(19) United States
(12) Patent Application Publication
(10) Pub. No.: US 2025/0307268 A1
(43) Pub. Date: Oct. 2, 2025

(54) CLUSTER INTERPRETATION USING A PERSISTENCE MEASURE

(71) Applicant: Providence St. Joseph Health, Renton, WA (US)

(72) Inventors: Mallajosyula Venkata Udai Shankar, Hyderabad (IN); Mudumby Ananta Sri Pallavi, Hyderabad (IN); Anudeep Srivatsav Appe, Warangal (IN); Ritik Srivastava, Lucknow (IN); Cibe Sridharan, Virudhunagar (IN); Preetha Kumar, Hyderabad (IN); Atmakuri Gowriah Hari Charan, Hyderabad (IN)

(21) Appl. No.: 18/618,986

(22) Filed: Mar. 27, 2024

(51) Int. Cl. G06F 16/28; G06F 16/2457

(52) U.S. Cl. CPC G06F 16/285; G06F 16/24573

(57) ABSTRACT

A facility for analyzing the features of data items organized into clusters is described. The facility analyzes the data items of the clusters when the features of the data items are high dimensional and categorical with overlapping values across the clusters. The facility identifies the most distinguishable features that uniquely differentiate the clusters given the above nature of the feature space.

### BACKGROUND

Data items can each possess one or more features. For example, data items representing patients can have features of a variety of types, including for example those relating to demographic characteristics, clinical observations, test results, procedures performed, and many others. Specific examples include age: 0-5, age: 6-10, age: 11-15, and so forth; obesity_history: yes; and head_MRI_performed: no. Such features for data items representing patients are often retrieved or derived from electronic medical record (“EMR”) systems.

In some cases, data items are each assigned to one of a set of clusters. For example, of a group of 500 data items each representing a patient, 212 may be assigned to a first cluster based on a subarachnoid hemorrhage diagnosis, while the other 288 are assigned to a second cluster based on an intracerebral hemorrhage diagnosis.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments in order to identify the features that distinguish each cluster from the others in a set of clusters.

FIG. 3 is a table diagram showing sample contents of a feature cooccurrence table used by the facility in some embodiments to store the result of counting the cooccurrence of feature pairs within a particular cluster.

FIG. 4 is a graph diagram showing a sample feature cooccurrence graph constructed by the facility in some embodiments.

FIG. 5 is a flow diagram showing a process performed by the facility in some embodiments to determine a perish score for each feature in each cluster.

FIG. 6 is a table diagram showing sample contents of a persistence analysis table that contains the array of features versus cluster established by the facility in act 501.

FIG. 7 is a table diagram showing the persistence analysis table updated to reflect the performance of act 502, i.e., the initialization of the analysis window to include only the top row of the array.

FIGS. 7-17 are table diagrams showing versions of the persistence analysis table reflecting the assignment of perish scores in accordance with the process shown in FIG. 5.

FIG. 18 is a table diagram showing a version of the persistence analysis table updated to reflect the performance of acts 207 and 208 to determine persistence scores and select features on the basis of persistence scores.

### DETAILED DESCRIPTION

The inventors have recognized that it can be useful to identify the features that distinguish the data items of one cluster from the data items of one or more other clusters. For example, it could be helpful to identify the features that distinguish the data items assigned to the subarachnoid hemorrhage from those assigned to other clusters, as well as those that distinguish the data items assigned to the intracerebral hemorrhage cluster from those assigned to other clusters.

The inventors have further recognized that conventionally-applied techniques for identifying these distinguishing features for clusters are ill-suited to domains like medicine in which data items have high dimensionality, and are qualified and connected by semantic relationships. In particular, they have recognized that the TF/IDF conventional technique used for identifying distinguishing features has its limitations while interpreting features in the context of overlapping clusters, particularly when the feature space is high dimensional and features are repetitive across clusters.

In response to recognizing these disadvantages of conventional techniques, the inventors have conceived and reduced to practice a software and/or hardware facility for cluster interpretation using a persistence measure (“the facility”). The persistence measure used in this approach quantifies an extent to which a feature is unique across clusters when features are highly overlapping among clusters.

In some embodiments, the facility generates a graph for each cluster that reflects the patterns of cooccurrence of features among those of individual data items of the cluster. The facility uses a technique such as PageRank to produce a value for each combination of cluster and feature that reflects the feature's level of connectedness—or “centrality”—among the data items of the cluster, based on the graph for the cluster. In cases where the dimensionality is significantly high, techniques for dimensionality reduction like maximal cliques are used to reduce the dimension of the feature space, before calculating the centrality measure.

The facility sorts the features for each cluster in descending order of their centrality values, and arranges these sorted lists of features in a rectangular array in which each cluster's sorted feature list is a column. The facility establishes a window that initially encompasses the top row of this array, but is later expanded downward by one row at a time. The facility determines a persistence measure for each combination of cluster and feature that is based on the number of these expansions for which the feature is in the window for that cluster, but not for any of the other clusters. For each of the clusters, the facility identifies the features with the highest persistence values as those that best distinguish its data items from those of the other clusters.

In some embodiments, the facility uses these features identified for each cluster to automatically predict, for a data item not assigned to a cluster, which cluster it would properly be assigned to. For example, where data items are patients and clusters are different types of cerebral hemorrhages that have been diagnosed in these patients, the facility uses the features identified for each of these clusters to predict which of them a new data item should be assigned to—i.e., which of the diagnoses would be correct for the patient represented by the new data item—based on which cluster's identified features best matches the features of the new data item.

In some embodiments, the facility uses these features identified for each cluster to automatically determine which kinds of information are collected, stored, retrieved, and/or analyzed as part of data items, such as, for example, such information with respect to patients for whom a particular differential diagnosis is to be automatically predicted and/or authoritatively determined.

By operating in some or all of the ways described above, the facility more effectively identifies features that distinguish the data items of a cluster from those of other clusters. In various circumstances, this enables a user to better understand the nature of the clusters and their members, better predict the proper cluster for new data items, etc.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by obviating the bag-of-words analysis process used by the TF/IDF approach, the facility avoids committing any processing resources to the performance of this process.

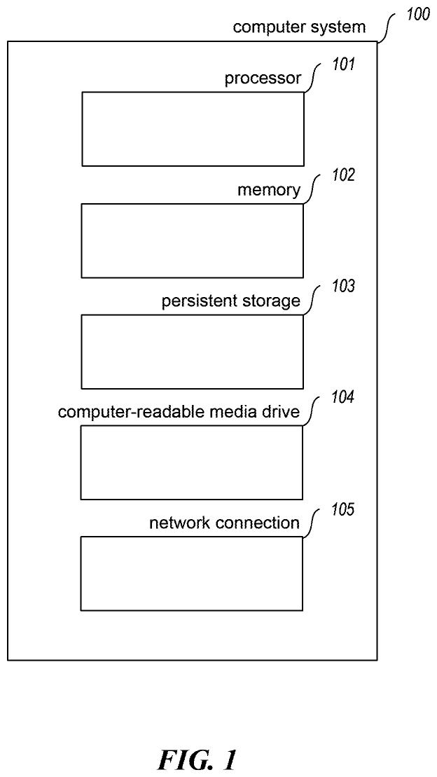

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

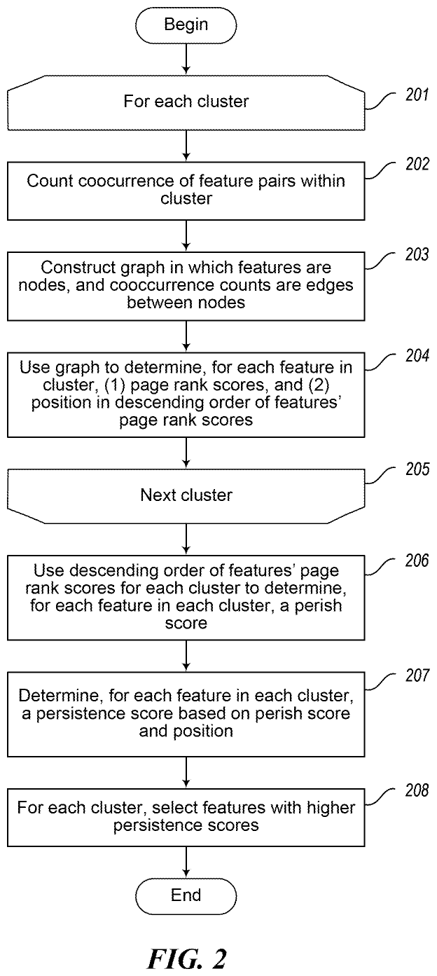

FIG. 2 is a flow diagram showing a process performed by the facility to identify the features that distinguish each cluster from the others in a set of clusters. In acts 201-205, the facility loops through each cluster of the set. In act 202, the facility counts the cooccurrence of feature pairs within individual data items of the cluster. In some embodiments, the facility counts cooccurrences of a pair of features that appear anywhere in an individual data item of the cluster. In some embodiments, the facility counts only cooccurrences of a pair of features that occur within a specified distance or window size of one another, such as five words. The facility identifies cooccurrences without regard for directionality or order, to produce undirected graph/data structure.

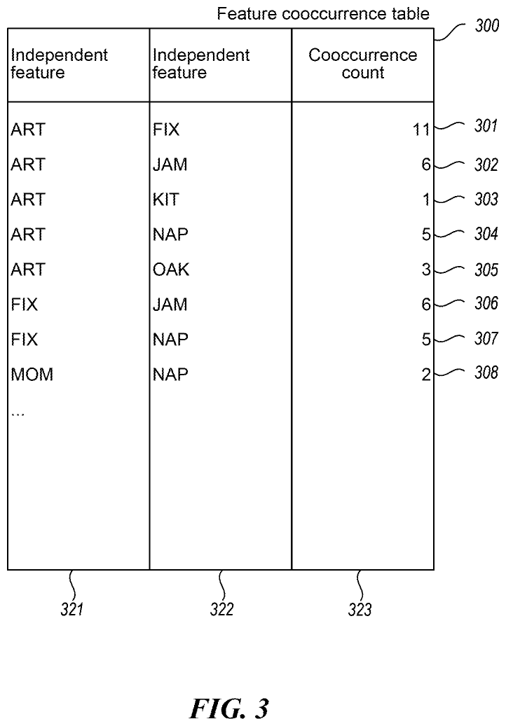

FIG. 3 is a table diagram showing sample contents of a feature cooccurrence table used by the facility in some embodiments to store the result of counting the cooccurrence of feature pairs within a particular cluster. In this case, the contents of feature cooccurrence table 300 reflect a cooccurrence count in a first cluster among a set of three clusters. The table contains rows, such as rows 301-308, each corresponding to a different pair of features. These features are identified in columns 321 and 322, and column 323 contains the cooccurrence count determined for the pair of features. For example, row 301 indicates that the facility determined a cooccurrence count of 11 for the features ART and FIX. As shown, the cooccurrences that are counted in the table are bidirectional cooccurrences. In embodiments in which the facility identifies unidirectional cooccurrences, the cooccurrence table contains two rows for each pair of features, one in each direction (not shown). For convenience, features are shown in this figure and later ones using simple words. In various embodiments, the features take various forms as stored in or for the data items. For example, where the data items represent patients, one feature may be whether the patient has a previously known medical history of the obesity/overweight condition, and this feature may be expressed as “gs_med_hist_21:1”.

While FIG. 3 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

Returning to FIG. 2, in act 203, the facility uses the feature cooccurrence counts obtained in act 202 to construct a graph in which features are nodes, and the cooccurrences counts are the weights of edges that each connect pairs of nodes. In some embodiments, the graph constructed by the facility in act 203 is undirected (in that none of the edges have directions).

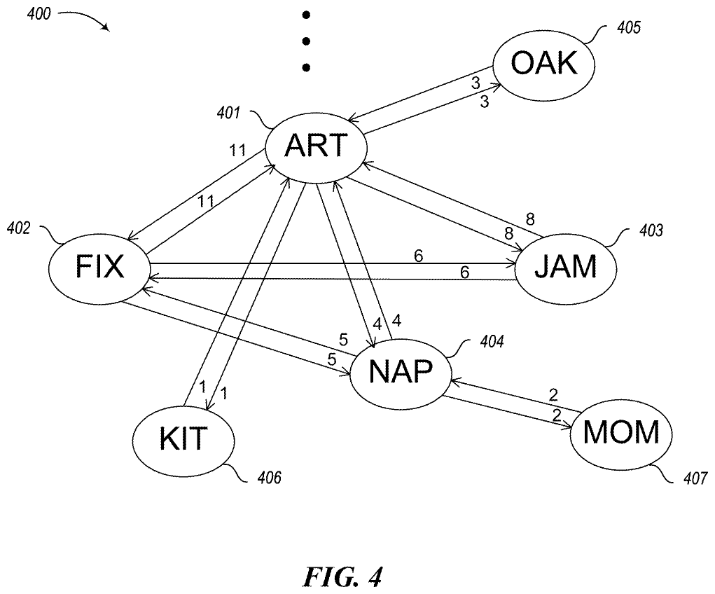

FIG. 4 is a graph diagram showing a sample feature cooccurrence graph constructed by the facility in some embodiments. In particular, the graph 400 corresponds to the cooccurrence counts in the feature cooccurrences table 300 appearing in FIG. 3 for some of the features present in the data items of the first cluster. Thus, the graph is incomplete with respect to all of the features of data items in the first cluster; nodes 401-407 are shown, and correspond to the following features, respectively: ART, FIX, JAM, NAP, OAK, KIT, and MOM. For each pair of these features that has a non-zero occurrence count in the feature cooccurrence table, corresponding nodes are connected by two edges, each having a weight equal to the noted cooccurrence count. For example, nodes 401 and 402 correspond to the features ART and FIX, as well as row 301 of the feature cooccurrence table shown in FIG. 3. The cooccurrence count of 11 shown in the row is repeated as the weight of each of these edges.

Returning to FIG. 2, in act 204, the facility uses the graph constructed in act 203 to determine, for each feature in the current cluster, both (1) a page rank score representing the level of connectedness or centrality of the feature among the data items of the cluster, and (2) the feature's position in an ordering of the features that is in descending order of their page rank scores. In some embodiments, page rank scoring is performed in accordance with the description in “PageRank”, available at en.wikipedia.org/wiki/PageRank, which is hereby incorporated by reference in its entirety. In act 205, if additional clusters remain to be processed, then the facility continues in act 201 to process the next cluster, else the facility continues in act 206.

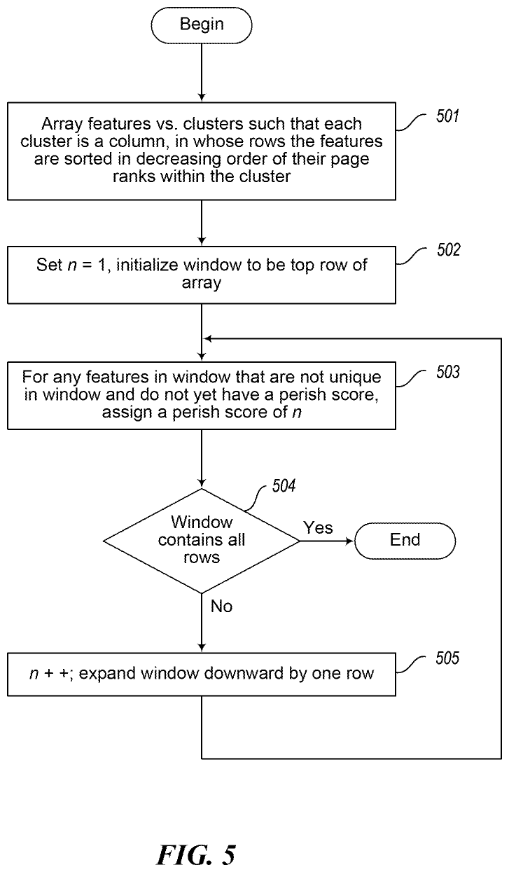

In act 206, the facility uses the descending order of the features' page rank scores for each cluster to determine, for each feature in each cluster, a perish score. Perish score represents the step size at which a feature of the cluster perishes i.e., when the feature is found to be present in the top step size list of other clusters. Additional details of act 206 are discussed below in connection with FIG. 5. In act 207, the facility determines, for each feature in each feature in each cluster, a persistence score that is based on the feature's perish score determined in act 206 and its position determined in act 204, such as by subtracting its position from its perish score. In act 208, for each cluster, the facility selects features having the highest persistence scores within the cluster as the features that most distinguish the cluster from the other clusters of the set. After act 208, this process concludes.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 5 is a flow diagram showing a process performed by the facility in some embodiments to determine a perish score for each feature in each cluster. In act 501, the facility arranges the features versus clusters in such a way that each cluster is a column, in whose rows the features are sorted in decreasing order of their page rank scores within the cluster.

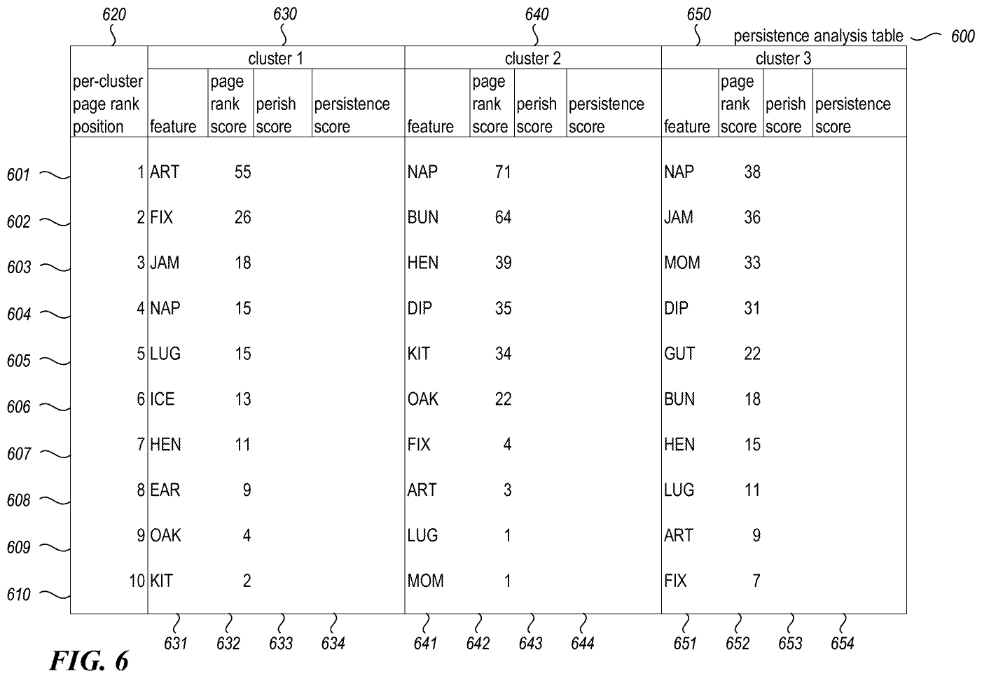

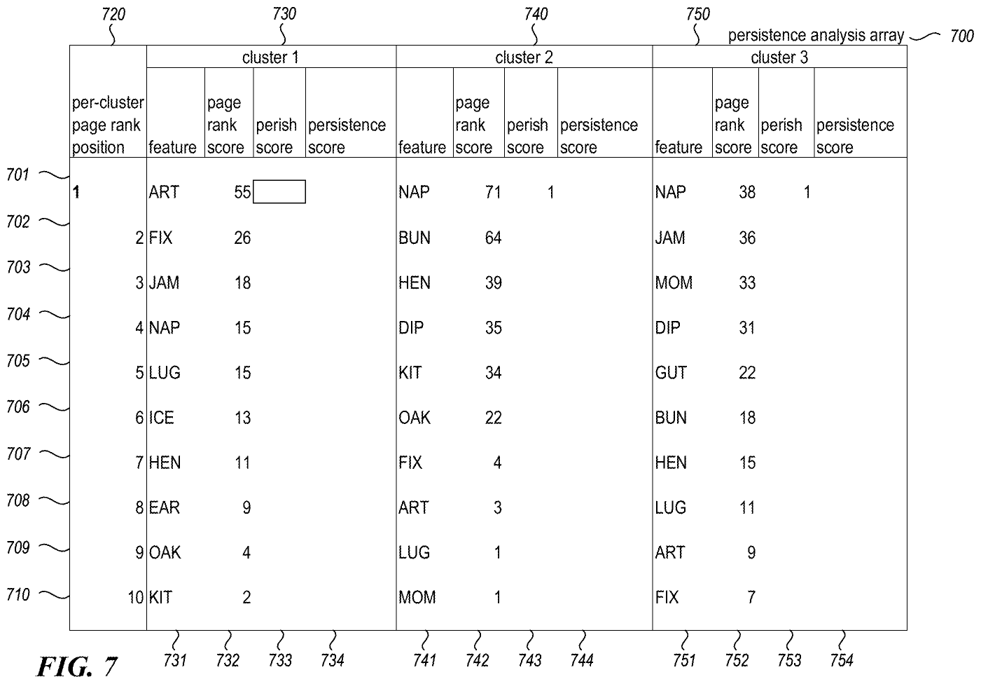

FIG. 6 is a table diagram showing sample contents of a persistence analysis table that contains the array of features versus cluster established by the facility in act 501. The persistence analysis table 600 is made up of a number of rows, such as rows 601-610, each corresponding to a different page rank score position. For example, row 601 corresponds to the top page rank position for all of the clusters. Supercolumn 630 corresponds to the first sample cluster in the sample set of three clusters; supercolumn 640 to the second cluster; and supercolumn 650 the third sample cluster. Each of these three supercolumns contains four constituent columns. For example, super cluster 630 for the first sample cluster contains the constituent columns feature column 631, page rank score 632, perish score column 633, and persistence score column 634. The other two supercolumns contain the same constituent columns. The feature constituent column identifies one of the features, and the page rank score identifies the page rank determined for that feature within the cluster represented by the containing supercolumn. For example, row 601 indicates that, in the first sample cluster, the feature ART has page rank 55. Within each supercolumn the features and their page rank scores are sorted in descending order of the page rank scores. FIGS. 7-18 discussed below contain the same arrangement of features versus clusters, and reflect progressive performance of the process described herein.

Returning to FIG. 5, in act 502, the facility sets a variable n=1, and initializes an analysis window to include the top row of the array only.

FIG. 7 is a table diagram showing the persistence analysis table updated to reflect the performance of act 502, i.e., the initialization of the analysis window to include only the top row of the array. By comparing version of the persistence analysis table to version 600 shown in FIG. 6, it can be seen that the numeral 1 at the intersection of row 701 and column 720 has been moved from the right side of the column to the left side of the column, and bolded, to reflect that this row is part of the analysis window. The fact that these changes have not been made at the intersection of rows 702-710 with column 720 reflects that they are not presently part of the window.

Returning to FIG. 5, in act 503, for any features that are presently in the window and are not unique within the window, and do not yet have a perish score, the facility assigns a perish score equal to the current value of the variable n. In act 504, if the window now contains all of the rows of the array, then this process concludes, else the facility continues in act 505. In act 505, the facility increments the value of the variable n, and expands the analysis window down by one row. In some embodiments (not shown), the facility expands the analysis window by an increment of more than one row at a time, such as two rows at a time, three rows at a time, five rows at a time, etc. After 505, the facility continues in act 503 to assign any perish scores implicated by the expansion of the window.

FIGS. 7-17 show versions of the persistence analysis table reflecting the assignment of perish scores in accordance with the process shown in FIG. 5. Returning to FIG. 7, version 700 of the persistence analysis table shown here reflects a window that includes only row 701. In this window, the feature NAP is not unique—it is present in supercolumn 740 for cluster 2, and supercolumn 750 for cluster 3. Accordingly, the facility assigns a perish score to the feature NAP for clusters 2 and 3 equal to the current version of the variable n, which is 1. This is seen at the intersection of row 701 with columns 743 and 753. On the other hand, the feature ART is still unique within this window, so a perish score is not yet assigned to the feature ART for cluster 1. This is reflected by the empty box at the intersection of row 701 with column 733.

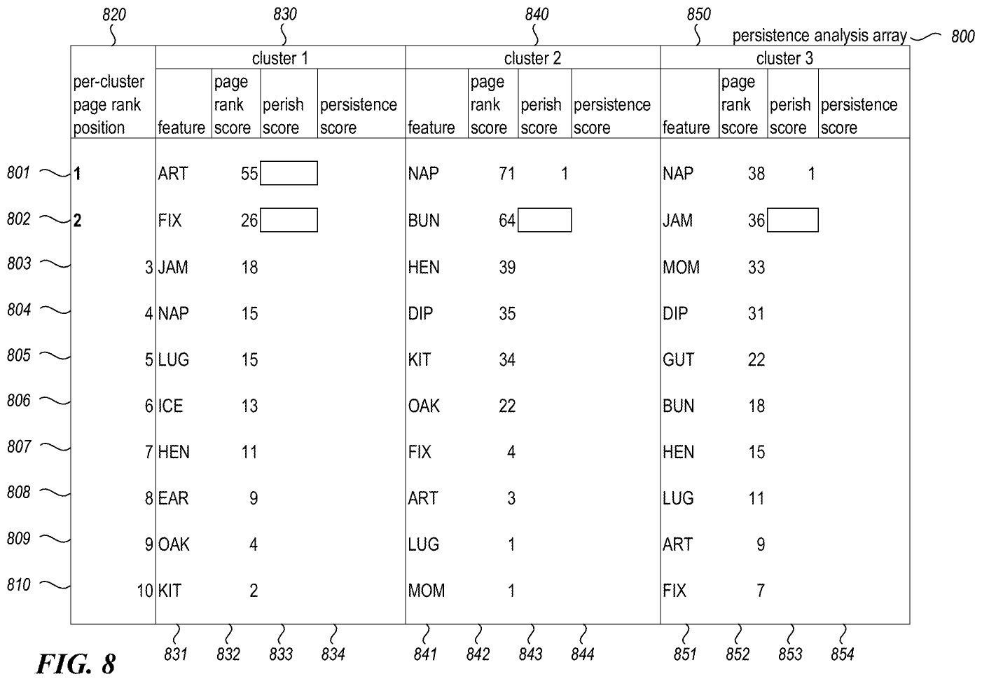

FIG. 8 is a table diagram showing the persistence analysis table updated to reflect the assignment of perish scores for the value 2 of the variable n. From the contents of column 820 of this version 800 of the persistence analysis array, it can be seen that the window for this value of the variable n includes rows 801-802, and not rows 803-810. By comparing FIG. 8 to FIG. 7, it can be seen that, during this iteration, the facility did not assign perish scores to any of the following features, based upon their uniqueness within the window: the feature FIX in cluster 1 (at the intersection of row 802 and column 833), the feature BUN in cluster 2 (at the intersection of row 802 and column 843), and the feature JAM in cluster 3 (at the intersection of row 802 and column 853). It can also be seen at the intersection of row 801 with row 833 that the facility is not assigned a perish score to the feature ART in cluster 1, as this feature is still unique within the window.

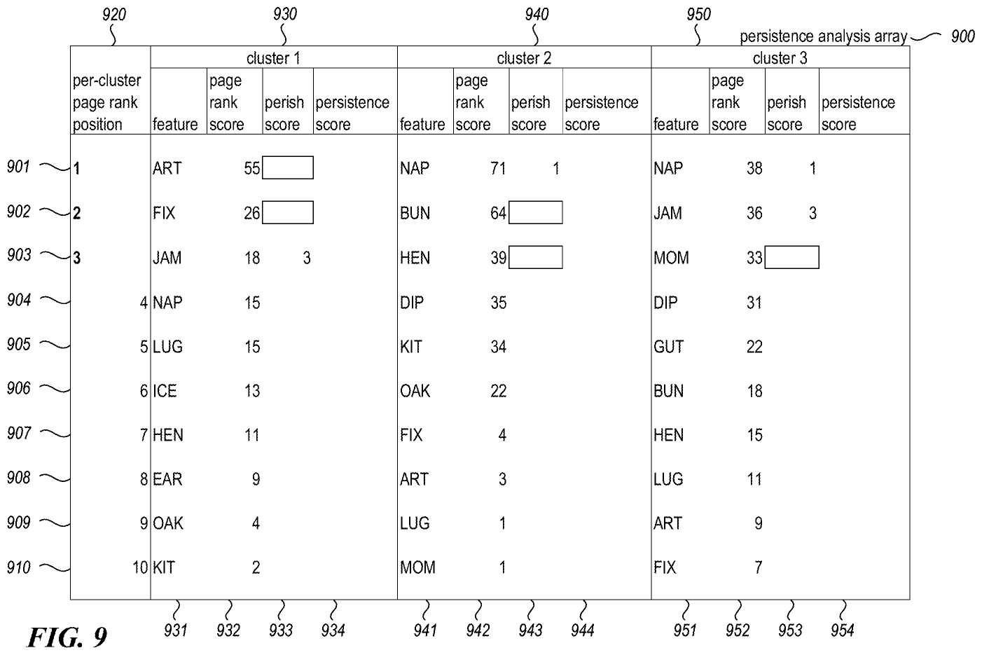

FIG. 9 is a table diagram showing the persistence analysis table updated to reflect the assignment of perish scores for the value 3 of the variable n. From the contents of column 920 of this version 900 of the persistence analysis array, it can be seen that the window for this value of the variable n includes rows 901-903, and not rows 904-910. By comparing FIG. 9 to FIG. 8, it can be seen that, during this iteration, the facility added the perish score of 3 for the feature JAM at the intersection of row 902 with column 953 and of row 903 with column 933.

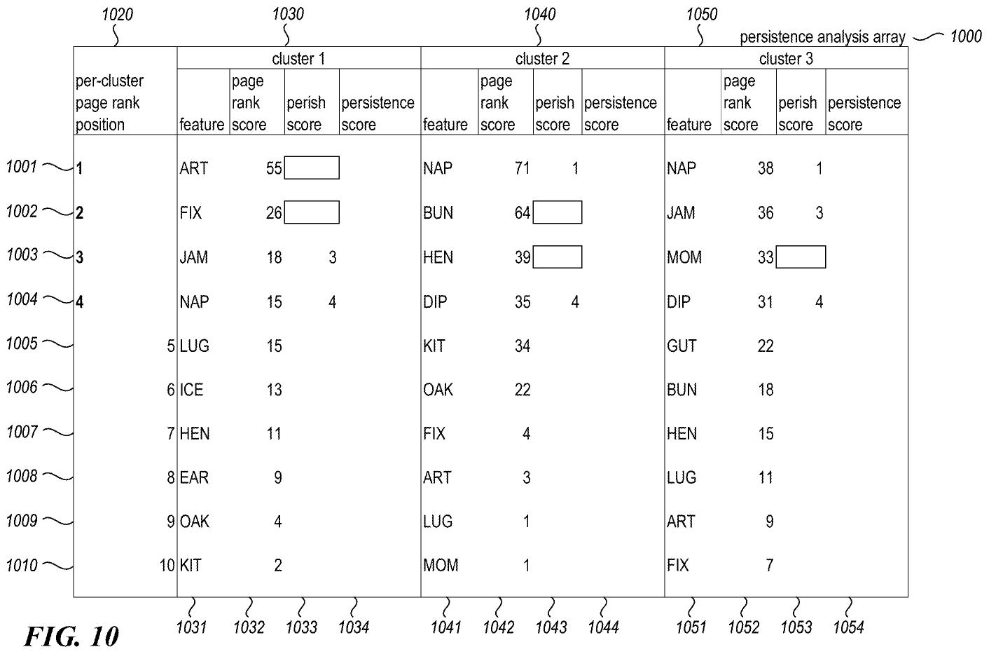

FIG. 10 is a table diagram showing the persistence analysis table updated to reflect the assignment of perish scores for the value 4 of the variable n. From the contents of column 1020 of this version 1000 of the persistence analysis array, it can be seen that the window for this value of the variable n includes rows 1001-1004, and not rows 1005-1010. By comparing FIG. 10 to FIG. 9, it can be seen that, during this iteration, the facility assigned the perish score of 4 to the NAP feature in cluster 1 as shown at the intersection of row 1004 with column 1033; and added the perish score of 4 for the DIP in the second and third clusters as shown at the intersection of row 1004 with columns 1043 and 1053.

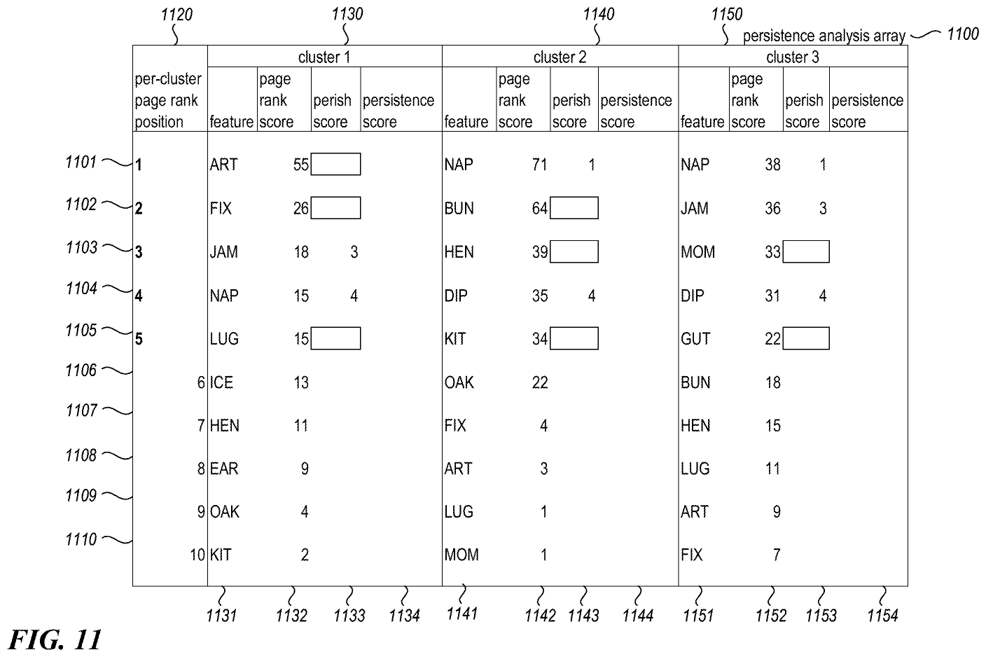

FIG. 11 is a table diagram showing the persistence analysis table updated to reflect the assignment of perish scores for the value 5 of the variable n. From the contents of column 1120 of this version 1100 of the persistence analysis array, it can be seen that the window for this value of the variable n includes rows 1101-1105, and not rows 1106-1110. By comparing FIG. 11 to FIG. 10, it can be seen that, the facility did not assign any perish scores during this iteration, since no combination of feature with cluster became non-unique in the new window.

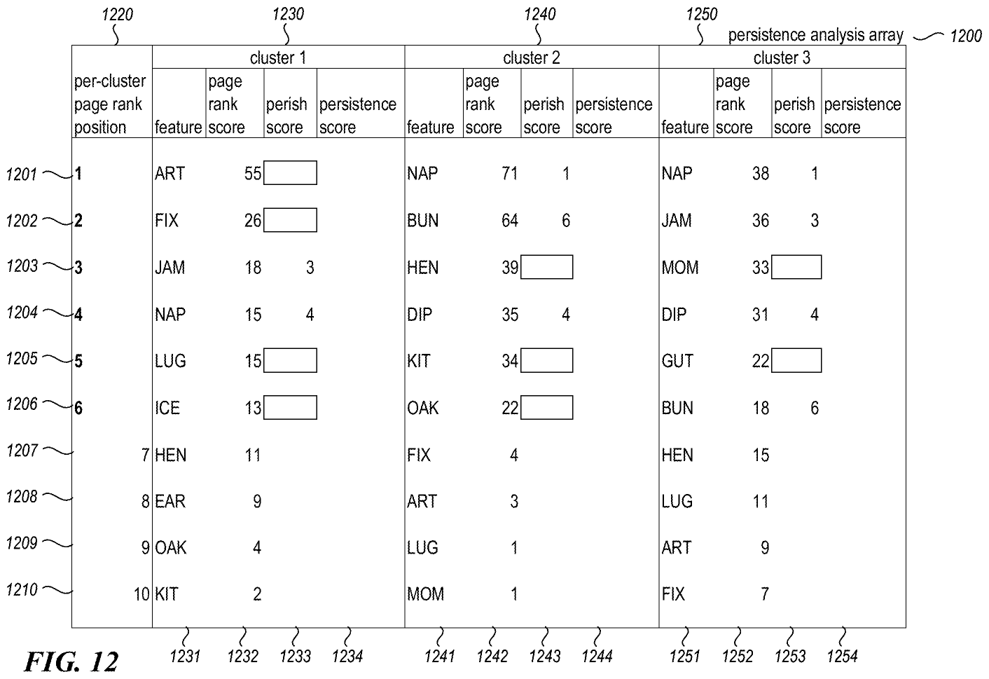

FIG. 12 is a table diagram showing the persistence analysis table updated to reflect the assignment of perish scores for the value 6 of the variable n. From the contents of column 1220 of this version 1200 of the persistence analysis array, it can be seen that the window for this value of the variable n includes rows 1201-1206, and not rows 1207-1210. By comparing FIG. 12 to FIG. 11, it can be seen that, during this iteration, the facility added the perish score of 6 to the feature BUN for cluster 2 as shown at the intersection of 1202 with column 1233, as well as for cluster 3 as shown at the intersection of 1206 with column 1253.

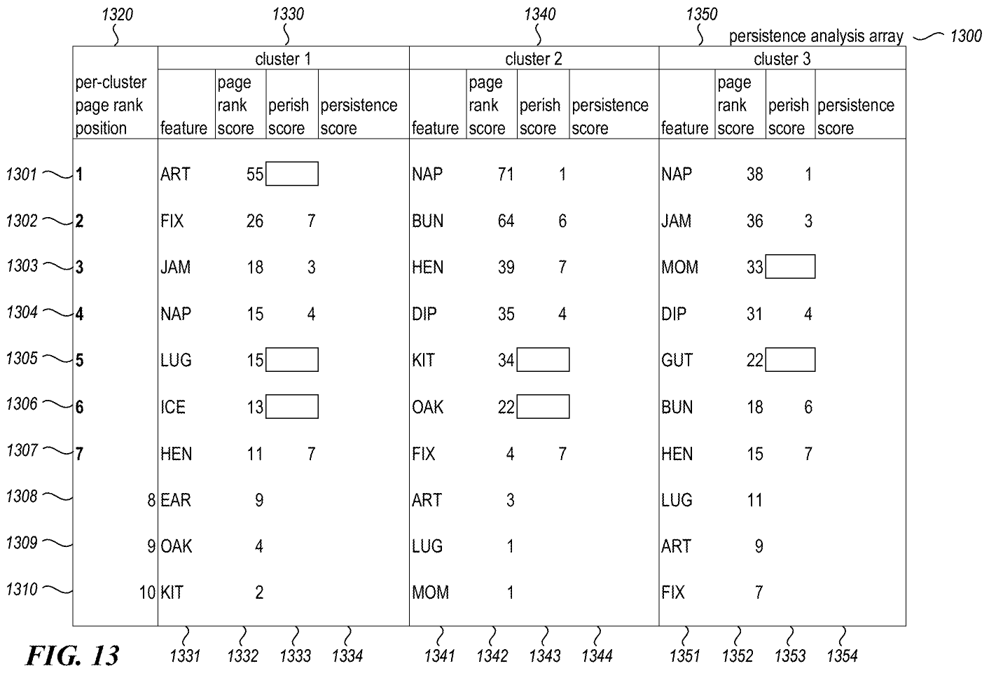

FIG. 13 is a table diagram showing the persistence analysis table updated to reflect the assignment of perish scores for the value 7 of the variable n. From the contents of column 1320 of this version 1300 of the persistence analysis array, it can be seen that the window for this value of the variable n includes rows 1301-1307, and not rows 1308-1310. By comparing FIG. 13 to FIG. 12, it can be seen that, during this iteration, the facility added a perish score of 7 to the feature FIX for cluster 1 as shown at the intersection of row 1302 and column 1333, and for cluster 2 as shown at the intersection of row 1307 with column 1343; and perish score 7 for the feature HEN in cluster 1 as shown at the intersection of row 1307 with column 1333, with cluster 2 as shown at the intersection of row 1303 with column 1343, and in cluster 3 as shown at the intersection of row of row 1307 with column 1353.

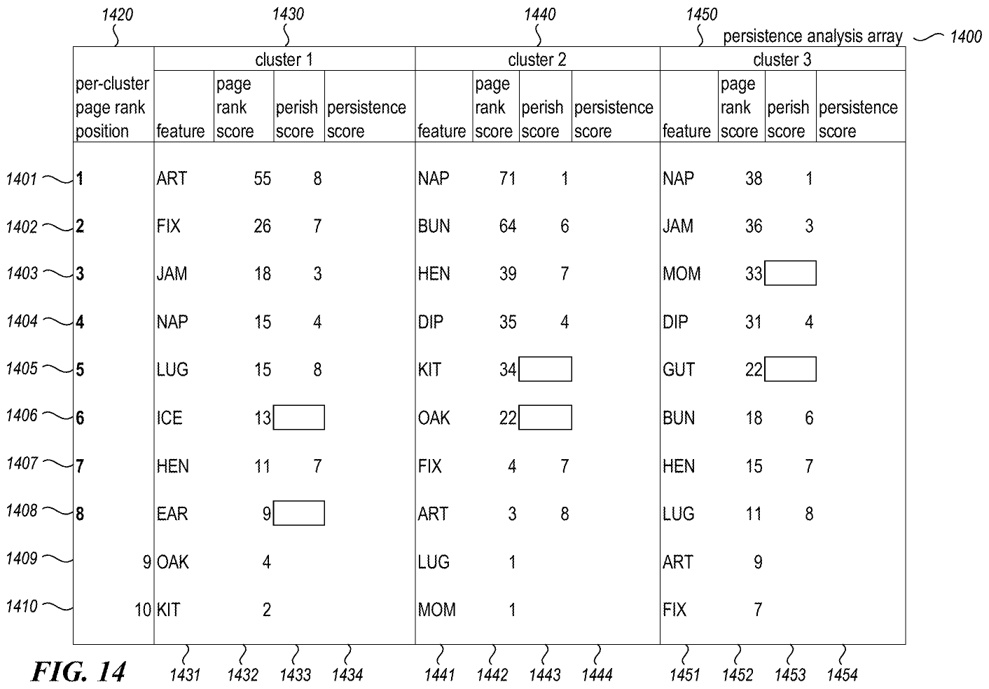

FIG. 14 is a table diagram showing the persistence analysis table updated to reflect the assignment of perish scores for the value 8 of the variable n. From the contents of column 1420 of this version 1400 of the persistence analysis array, it can be seen that the window for this value of the variable n includes rows 1401-1408, and not rows 1409-1410. By comparing FIG. 14 to FIG. 13, it can be seen that, during this iteration, the facility added perish score 8 for the ART feature in cluster 1 as shown at the intersection of row 1401 with column 1433, and in cluster 2 as shown at the intersection of row 1408 with column 1433; and added the perish score 8 for the feature LUG in cluster 1 as shown at the intersection of row 1405 with column 1433, and in cluster 3 as shown at the intersection of row 1408 with column 1453.

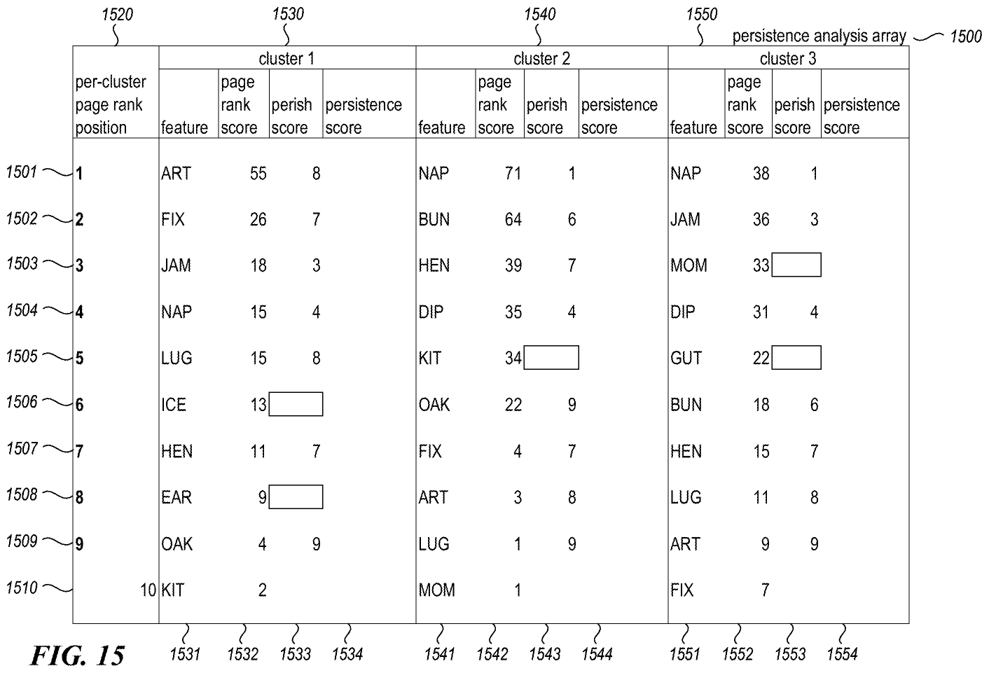

FIG. 15 is a table diagram showing the persistence analysis table updated to reflect the assignment of perish scores for the value 9 of the variable n. From the contents of column 1520 of this version 1500 of the persistence analysis array, it can be seen that the window for this value of the variable n includes rows 1501-1509, and not row 1510. By comparing FIG. 15 to FIG. 14, it can be seen that, during this iteration, the facility added perish score 9 for the feature OAK in cluster 1 as shown at the intersection of row 1509 with column 1533, and in cluster 2 as shown at the intersection of row 1506 with column 1543; added the perish score 9 for the feature LUG in cluster 2 as shown at the intersection of row 1509 with column 1543; and added the perish score of 9 for the feature ART as shown at the intersection of row 1509 with column 1553.

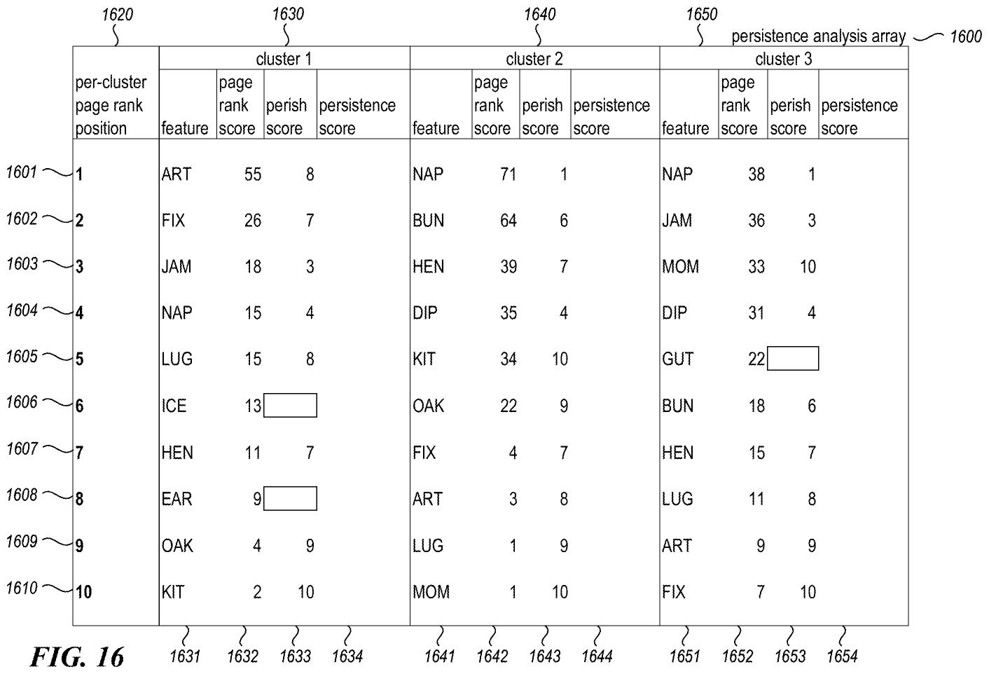

FIG. 16 is a table diagram showing the persistence analysis table updated to reflect the assignment of perish scores for the value 10 of the variable n. From the contents of column 1620 of this version 1600 of the persistence analysis array, it can be seen that the window for this value of the variable n includes rows 1601-16010. By comparing FIG. 16 to FIG. 15, it can be seen that, during this iteration, the facility added the perish score 10 for the feature KIT in cluster 1 as shown at the intersection of row 1610 with column 1633, and in cluster 2 as shown at the intersection of row 1605 with column 1643; added the perish score of 10 for the feature MOM in cluster 2 as shown at the intersection of row 1610 with column 1643, and in cluster 3 as shown at the intersection of row 1603 with column 1653; and added the perish score of 10 for the feature FIX in cluster 3 as shown at the intersection of row 1610 with column 1653.

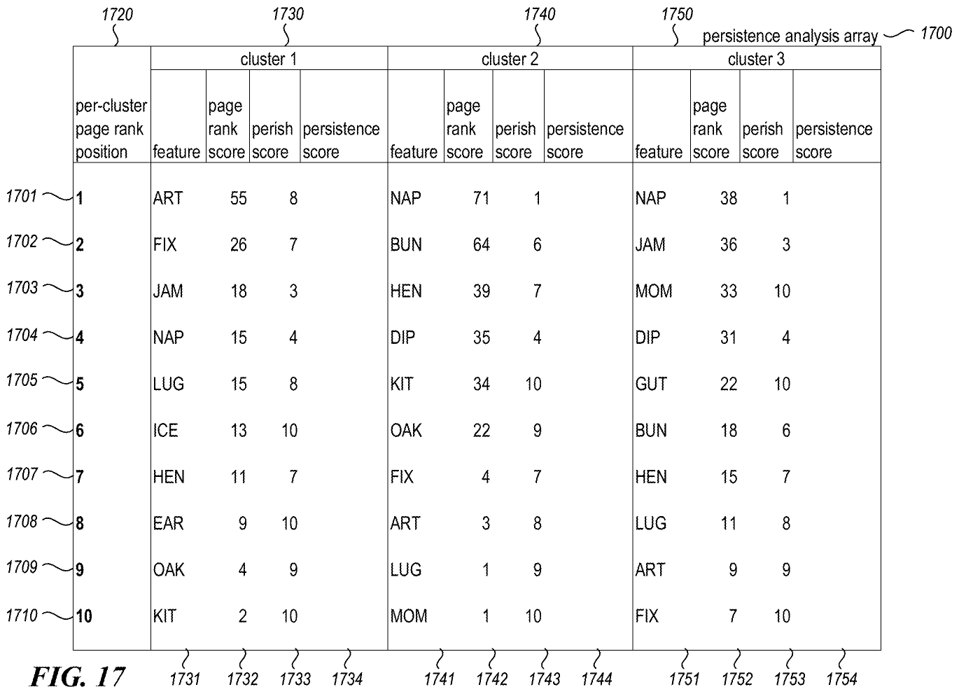

FIG. 17 is a table diagram showing the persistence analysis table updated to reflect the assignment of perish scores to features that remain unique within the fully-expanded window. From the contents of column 1720 of this version 1700 of the persistence analysis array, it can be seen that the window is still fully expanded to contain rows 1701-1710. By comparing FIG. 17 to FIG. 16, it can be seen that the facility has added a perish score 10 for each of the features remain unique within the fully-expanded window: ICE in cluster 1 as shown at the intersection of row 1706 with column 1733; EAR in cluster 1 as shown at the intersection of row 1708 with column 1733, and GUT in cluster 3 as shown at the intersection of row 1705 with column 1753. In various embodiments, the facility assigns a perish score to these still-unique features that is equal to the highest perish score assigned to a non-unique feature, or that is larger to some degree than the highest perish score assigned to a non-unique feature. In this case, the highest perish scored assigned to a non-unique feature is the perish score 10, assigned to the features KIT and MOM. As shown in persistence analysis array 1700, the perish score of 10 has been assigned to the three unique features; in various embodiments, the facility assigns perish scores greater than 10 to these unique features.

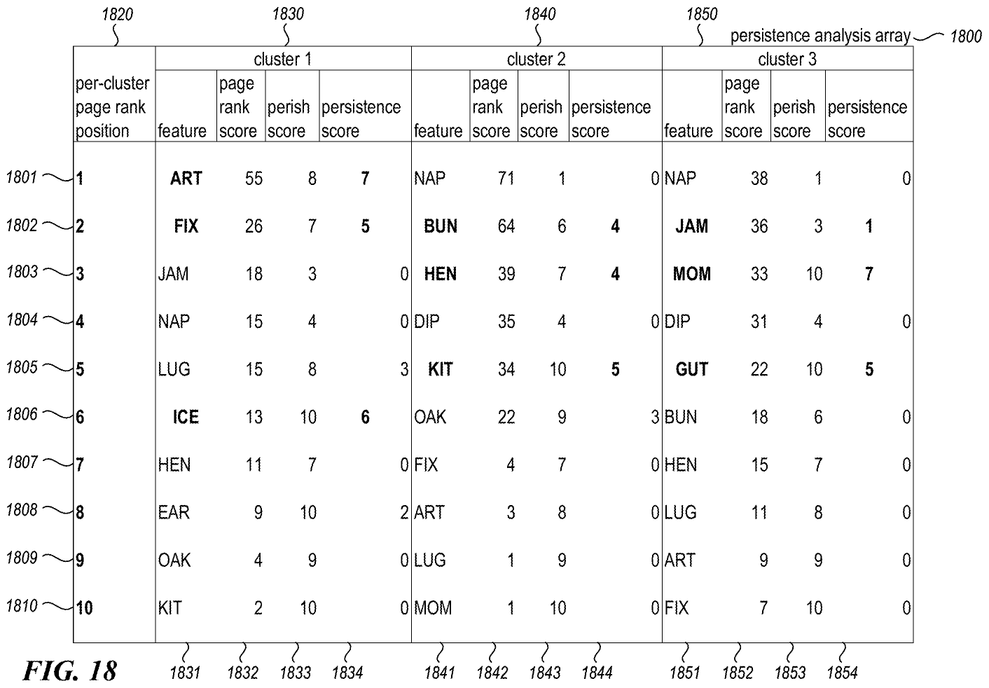

FIG. 18 is a table diagram showing a version of the persistence analysis table updated to reflect the performance of acts 207 and 208 to determine persistence scores and select features on the basis of persistence scores. By comparing this version 1800 of the persistence analysis array to version 1700 shown in FIG. 17, it can be seen that the facility has populated persistence score columns 1834, 1844, and 1854 with persistence scores for each combination of feature and cluster. For example, the intersection of row 1801 with column 1834 shows that the facility has populated a persistence score of 7 for the feature ART in cluster 1. This persistence score is obtained by the facility by subtracting the value of n for this row 1801 (1, as shown at the intersection of row 1801 with column 1820) from the perish score of 8 as shown at the intersection of row 1801 with column 1833. The facility determines a persistence score for the other 29 combinations of features with cluster in the same manner.

Persistence analysis array 1800 further indicates the facility's identification of the features that most distinguish each cluster from the other clusters of the set. In particular, for the persistence score column in each cluster supercolumn, the facility selects the highest persistence scores and the corresponding features for that cluster. For example, among the persistence scores shown for cluster 1 in column 1834, the highest are 7 for the ART feature, 6 for the ICE feature, and 5 for the FIX feature. Accordingly, the facility selects the ART, ICE and FIX features as those that most distinguish cluster 1 from the other two sample clusters. This is indicated by the bolding and centering of these features and their persistence scores in supercolumn 1830. The facility performs the same process with respect to cluster 2 to identify for it the features KIT, BUN, and HEN, and also for cluster 3 to identify the features MOM, GUT, and JAM.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system, comprising:
accessing a multiplicity of data items organized into a plurality of clusters, such that each data item of the multiplicity is a member of exactly one cluster; each data item having one or more of a plurality of features;
for each of the clusters:
analyzing cooccurrence of features in individual data items of the cluster to obtain, for each feature, a measure of the feature's centrality among data items of the cluster;
establishing for the cluster a sorted list of the features in descending order of their obtained centrality measures;
for each combination of one of the features with the cluster, initializing to empty a perish score and a persistence score;
for each of a plurality of positions across the centrality measure lists of the clusters, beginning at a top of the lists containing the highest centrality measure of each centrality measure list and having an initial position number, and progressing to positions having increasingly lower centrality measures in the centrality measure lists and progressively higher position numbers:
establishing a window encompassing from the top of each centrality measure list to the current position in each centrality measure list, across the centrality measure lists;
for each feature that is not unique within the current window:
for each cluster whose combination with the feature has an empty perish score within the current window:
storing the current position number as the perish score of the combination of the cluster and the feature; and
for each combination of cluster and feature:
determining a persistence score for the combination of cluster and feature reflecting a degree to which the feature distinguishes items of the cluster from items of other clusters of the plurality of clusters, by determining a difference between the perish score determined for the combination of cluster and feature and the position number in the centrality measure list for the cluster at which the feature occurs.

2. The method of claim 1 wherein the analyzing comprises:
for each of the clusters:
constructing a graph reflecting the patterns of feature cooccurrence among the data items of the cluster; and
performing a process against the graph to produce centrality measures for each of the features among data items of the cluster.

3. The method of claim 2 wherein the performed process produces PageRank centrality measures,
and wherein the constructed graph is a undirected graph.

4. The method of claim 1, further comprising:
for each of one or more of the clusters:
identifying as distinguishing features one or more features having the highest persistence scores for the cluster.

5. The method of claim 1, further comprising:
for each of one or more of the clusters:
displaying visual indications of one or more of the features based on their persistence scores for the cluster.

6. The method of claim 1, further comprising:
receiving information identifying features of a distinguished data item; and
using the persistence scores for each cluster of at least a portion of the identified features to predict a proper cluster for the distinguished data item.

7. One or more memories collectively storing a data structure, the data structure comprising:
a rectangular array of elements arranged into rows and columns, each column corresponding to a different one of the plurality of clusters, each row corresponding to a different centrality position, each element representing a combination of (1) the cluster to which the column containing the element corresponds with (2) the centrality position to which the row containing the element corresponds and comprising an indication of one of the plurality of features each possessed by at least some of a plurality of data items each contained by one of the clusters, each element comprising information identifying one of the features of the plurality that occupies the centrality position to which the row containing the element corresponds for the cluster to which the column containing the element corresponds,
such that the contents of the data structure are usable to determine perish score and a persistence score for each of the elements.

8. The one or more memories of claim 7, each element further comprising a perish score determined for the element.

9. The one or more memories of claim 7, each element further comprising a persistence score determined for the element.

10. One or more memories collectively having contents configured to cause a computing system to perform a method, the method comprising:
accessing a multiplicity of data items organized into a plurality of clusters, such that each data item of the multiplicity is a member of exactly one cluster; each data item having one or more of a plurality of features;
for each combination of one of the clusters with one of the features:
determining a measure of the feature's centrality among data items of the cluster;
for each cluster:
establishing a sorted list of the features in descending order of the features' centrality measures for the cluster; and
arranging the established sorted lists into a rectangular array in which each cluster's sorted feature list is a column.

11. The one or more memories of claim 10, the method further comprising:
establishing a window that initially encompasses at least the top row of the rectangular array;
progressively expanding, across multiple expansion acts, the window downward until it encompasses all of the rows of the rectangular array;
for each combination of one of the clusters with one of the features:
determining a persistence measure for the combination is based on the number of expansions for which the feature is in the window for the cluster, but not for any of the other clusters.

12. The one or more memories of claim 11 wherein determining the persistence measure comprises determining a perish score.

13. The one or more memories of claim 11 wherein each expansion act expands the window downward by one row.

14. The one or more memories of claim 11 wherein each expansion act expands the window downward by a predetermined number of rows greater than one.

15. The one or more memories of claim 11, the method further comprising:
for each of one or more of the clusters:
identifying as distinguishing features one or more features having the highest persistence scores for the cluster.
